(19) United States
(12) Patent Application Publication
(10) Pub. No.: US 2012/0109965 A1
(43) Pub. Date: May 3, 2012

(54) SYSTEM FOR AUTOMATIC SEMANTIC-BASED MINING

(75) Inventors: A/L Perumal Nagendran, Kuala Lumpur (MY); Yuan Kai Chow, Kuala Lumpur (MY); Yusrin Amruddin Amru, Kuala Lumpur (MY)

(73) Assignee: Mimos Derhad, Kuala Lumpur (MY)

(21) Appl. No.: 13/259,388

(22) PCT Filed: Mar. 23, 2010
(86) PCT No.: PCT/MY2010/000033

§ 371 Date: Jan. 7, 2012

(30) Foreign Application Priority Data
Mar. 23, 2009 (MY) PI 20091166

(51) Int. Cl. G06F 17/30

(52) U.S. Cl. 707/740; 707/776; 707/E17.108; 707/E17.089

(57) ABSTRACT

The present invention relates generally to a system for automatic semantic-based mining that enables web mining for populate semantic artifacts data to be carried out with minimal user interaction.

### TECHNICAL FIELD OF THE INVENTION

The present invention relates generally to a system for automatic semantic-based mining that enables web mining for populate semantic artifacts data to be carried out with minimal user, interaction.

### BACKGROUND OF THE INVENTION

Today the World Wide Web (WWW) continues to grow at an astounding rate in both the sheer volume of traffic and the size and complexity of Web sites. The complexity of tasks such as Web site design, Web server design and simply navigating through a Website have increased in tandem with its growth. Such tremendous and explosive growth of information sources in the World Wide Web introduced by Tim Berners-Lee necessitates utilisation of automated tools in order to search, extract, filter and evaluate the required information and resources. Hence the transformation of the Web into a primary tool for electronic commerce and research resulting in the creation of server-side and client-side intelligent systems that can effectively mine for knowledge both across the Internet and in particular Web localities. Web mining is the application of data mining techniques to discover patterns from the Web. It enables extraction of interesting and potentially useful patterns and implicit information from artifacts or activity related to the World Wide Web. One of the web mining category is Web content mining. Web content mining is the process to discover useful information from text, image, audio or video data in the web and it includes web document text mining, resource discovery based on concepts indexing or agent based technology. It is a process of extracting knowledge from the content of documents or their descriptions. There are two groups of web content mining strategies, those that directly mine the content of documents and those that improve on the content search of other tools like search engines. Web content mining is an automatic process that goes beyond keyword extraction. Currently the World Wide Web is based mainly on documents written in Hypertext Markup Language (HTML), a markup convention that is used for coding a body of text interspersed with multimedia objects such as images and interactive forms. Humans are capable of using the Web to carry out certain tasks such as looking for an English word in another language, searching for certain book titles or for the latest version of books and so on. However a computer being a machine require user intervention or direction to accomplish a required task as the web pages are designed to be read by humans and not by machines. Since the content of a text document presents no machine-readable semantic, some approaches have suggested restructuring the document content in a representation that could be exploited by machines. The usual approach to exploit known structure in documents is to use wrappers to map documents to some data model.

As it is not possible for machines to appropriately interpret code based on nothing but the order of relationships of letters, a specifically built semantic web coding system is necessary. The Semantic web (an extension of the World Wide Web in which the semantics of information and services on the web is defined, making it possible for the web to understand and satisfy the requests of people and machines to use the web content) is a vision of information that is understandable by computers, so that they can perform more elaborate and tedious tasks involved in the searching, procuring, sharing and combining information on the web. The Semantic Web involves publishing in languages specifically designed for data: Resource Description Framework (RDF), Web Ontology Language (OWL) and Extensible Markup Language (XML). HTML describes documents and links between them. RDF, OWL and XML, by contrast, can describe arbitrary things such as people, meetings or aeroplane parts. These technologies are combined in order to provide descriptions that supplement or replace the content of the Web documents. Thus, content may manifest as descriptive data stored in Web accessible databases or as markup within documents (particularly, in Extensible HTML [XHTML] interspersed with XML, or, more often, purely in XML, with layout or rendering cues to be stored separately). The machine-readable descriptions enable content managers to add meaning to the content that is to describe the structure of the knowledge itself, instead of text, using processes similar to human deductive reasoning and inference, thereby obtaining more meaningful results and facilitating automated information gathering and research by computers. For instance text-analysing techniques can now be easily bypassed by using other words, metaphors for instance, or by using images in place of words.

However there are setbacks in the existing system of web mining in that there is still a high degree of user interaction involved when mining for artifacts. The importance of minimising user interaction towards the direction of automation is vital as it speeds up discovery and extraction of information from the Web. Also as the backbone of the semantic web are ontologies (which are at present often hand crafted) wide-range application of the semantic web technologies are delayed or hindered if user interaction is not kept to a minimum.

It would hence be extremely advantageous if the above shortcoming is alleviated by having a system that enables an automatic semantic based web mining for artifacts data which is able to define ontologies and/or instances of their concepts and can be carried out with minimal user interaction.

### SUMMARY OF THE INVENTION

Accordingly, it is the primary aim of the present invention to provide a system that enables web mining for populate semantic artifact data which is capable of being carried out with minimal user interaction.

Yet another object of the present invention is to provide a system that enables web mining for populate semantic artifact data that allows discovery and extraction of useful information from the Web by merely inserting selected keywords.

It is another object of the present invention to provide a system that enables web mining for populate semantic artifact data that allows a quick and speedy discovery and extraction of useful information from the Web.

It is yet a further object of the present invention to provide a system that enables web mining for populate semantic artifact data that allows a systematic and objective discovery and extraction of useful information from the Web.

Yet a further object of the present invention is to provide a system that enables web mining for populate semantic artifact data that improves the results of web mining.

Other and further objects of the invention will become apparent with an understanding of the following detailed description of the invention or upon employment of the invention in practice.

According to a preferred method of the present invention there is provided,

A method of semantic web mining comprising steps of,

inserting at least a keyword into the web page;

posting said keyword to a mining agent;

collecting data mined from the Internet;

storing data for future retrieval of knowledge

characterised in that

the said posting of keyword to the mining agent is subsequent to the keyword being refined;

the said storing of data is subsequent to determination of the mime (Multi-Purpose Internet Mail Extension) type of data collected and after causing the determined type of data to undergo relevant semantic processing application and verification.

In another aspect of the invention there is provided,

A method of semantic web mining comprising steps of,

inserting at least a keyword into the web page;

posting said keyword to a mining agent

collecting data mined from the Internet;

storing data for future retrieval of knowledge

characterised in that

the said storing of data is subsequent to determination of the mime (Multi-Purpose Internet Mail Extension) type of data collected and after determined type of data to undergo relevant semantic processing application and verification.

### BRIEF DESCRIPTION OF THE DRAWINGS

Other aspect of the present invention and their advantages will be discerned after studying the Detailed Description in conjunction with the accompanying drawings in which:

FIG. 1 is a simplified flow chart of a system for automated semantic-based web mining.

FIG. 2 is a detailed flow chart of a system for automatic semantic-based web mining.

FIG. 3 illustrates the architecture of the web mining agent employed in the present invention.

### DETAILED DESCRIPTION OF THE DRAWINGS

In the following detailed description, numerous specific details are set forth in order to provide a thorough understanding of the invention. However, it will be understood by those or ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings which are not drawn to scale.

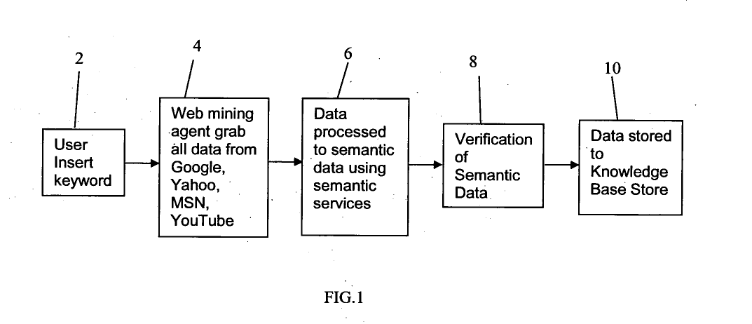

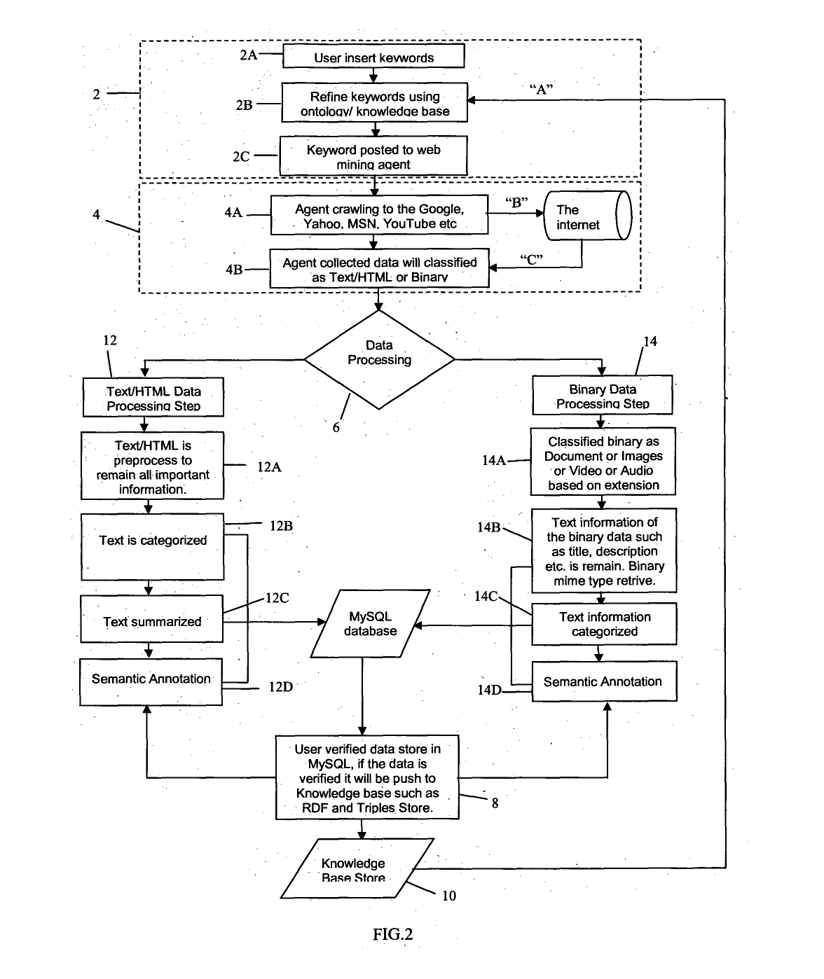

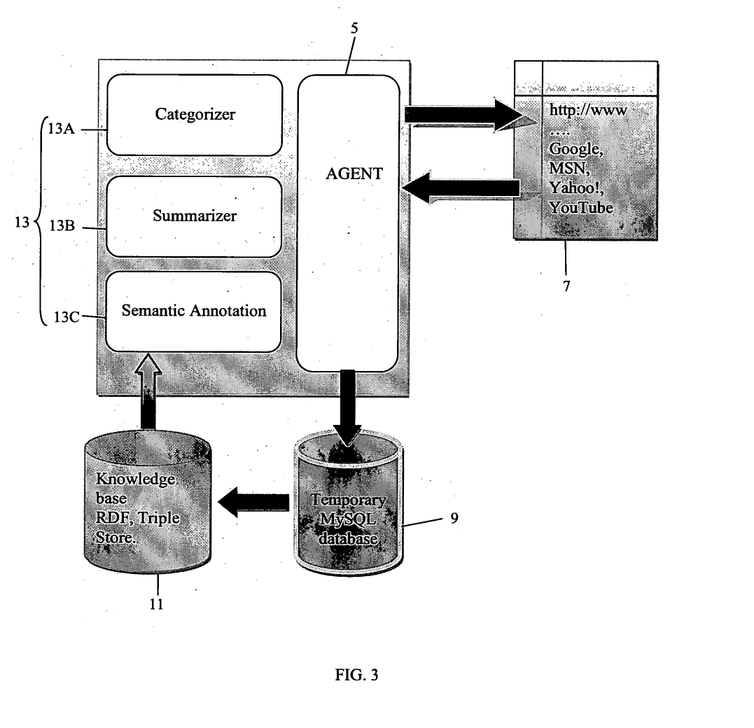

Referring to the drawings in which like numerals indicate like parts throughout the views shown, FIG. 1 shows a simplified flow chart of a system for an automated semantic-based Web Mining and FIG. 2 shows a detailed flow chart of a system for automatic semantic-based web mining. The simplified architecture as shown in FIG. 1 illustrates five steps namely a keyword insertion step indicated by the first block (2), a web mining step as indicated by the second block (4), a data processing step as indicated by the third block (6), a verification of semantic data step as indicated by the fourth block (8) and a data storage step as indicated by the fifth block (10). Firstly, in the keyword insertion step (2) at least a selected keyword related to the information to be discovered is inserted by the user into the web page. Thereafter the keyword is posted to the a web mining agent which is employed to grab all data from the Internet such as Google, Yahoo, MSN, You Tube etcetera which has relevance to the keyword or keywords inserted in the web mining step (4). Then the data that is collected is processed into semantic data using semantic services to transform plain internet data into machine-readable data in the data processing step (6). The processed data is then verified by the user in the semantic data verification step (8) for storage in a knowledge base store preferably knowledge base RDF or Triples store as depicted in the data storage step (10). The web mining agent employed in the system is illustrated in FIG. 3 which is a known web mining agent (5) developed using PHP technology and a known database. It is able to be programmed to crawl over the Internet (7), mining the data therein and temporarily storing it to a database (9). The temporarily stored data is then stored in a permanent knowledge base RDF or Triples Store (11) for subsequent semantic processing applications using Java technology such as a categorizer service (13A), a summarizer service (13B) and a semantic annotation (13C) to be carried out.

FIG. 2 shows a detailed flow chart showing the workings of an automatic semantic-based web mining. The said figure shows the process in FIG. 1 in more detail. Firstly, the user inserts at least a keyword into the web page as shown in the first keyword insertion step indicated by block (2A). Next the keyword is refined in the second keyword insertion step indicated by block (2B) which is done by verifying the said inserted keyword based on some suggestion of keywords from the ontology or knowledge base retrieved from the knowledge base store (10) where existing keywords are being stored for retrieval. The retrieval of keywords from the knowledge base store (10) is indicated by the arrow. “A”. It is to be understood that the invention is also workable if the keywords are not firstly refined but posted to the mining agent as is originally inputted by the user. The verified keyword is then posted to the web mining agent as variables in the web mining step (4) as described in the following paragraph. The first, second and third keyword insertion steps (2A) (2B) and (2C) are collectively known as the keyword insertion step (2) in FIG. 1.

In the first web mining step (4A), a web mining agent preferably employing known PHP and a known database as described in FIG. 3 is utilised. The PHP is programmed to crawl over the Internet as shown by the arrow “B” to mine data. Using the HTML information, the keywords inputted from the user will be posted to the various search engines such as Google Search Engine, Yahoo Search Engine, MSN Search Engine, YouTube, Google Images, Yahoo Images, MSN Images, Yahoo Video and 4Shared to enable mining of data for storage for later retrieval. All results from these sites will be queried in the second web mining step (4B) using DOM Xpath language and the information of each links will be harvested and directed to the mining agent as shown by the arrow “C”. XPath (XML Path Language) is a language for selecting nodes from an XML document. In addition, XPath may be used to compute values (strings, numbers, or boolean values) from the content of an XML document. XPath was defined by the World Wide Web Consortium (W3C). HMTL is part of XML document. Then the mining agent will collect all plain internet data/web data and the said data will be classified to determine the mime type of the data into text data (HTML or Text document) or binary data in the second web mining step (4B). The first and second web mining steps (4A) and (4B) are collectively known as the web mining step (4) in FIG. 1.

After the mime type of data is determined, the data proceeds to the next phase, the data processing step (6) which is generally a process to convert plain internet data/web data provided by the mining agent into semantic artifact using semantic services. The data processing step (6) comprises a text data processing step (12) and a binary data processing step (14). The type of data processing step applicable depends on the mime type of data. If the data is a text/HTML document a text data processing step (12) comprising several semantic processing applications (such as pre-processor service, categorizer service, summarizer service and semantic annotation) defined as web services, are consecutively applied to the text data to convert the web data into semantic artifact. In the first text data processing step as indicated by block (12A), the mining agent will take all collected data to a preprocessor service where all tags inside text or HMTL content will be slashed out. In this phase the preprocessor service created using JAVA has the capability to recognize the most valuable information inside text or html data. Only the pure text with important information is returned back to the agent by preprocessor service.

Next, the mining agent will assist all preprocessed data to proceed to the second text data processing step as indicated by block (12B) wherein the preprocessed data undergoes a categorizer service. This categorizer service (12B) will process and analyse all data retrieved based on its pre-determined calculations and rules. Then each data (or categories value) will be returned by the categorizer service to the mining agent in its respective categories which will then be temporarily stored in a database (13), with predicate “hasCategory” and the name of category.

Next, the mining agent will assist the preprocessed data to proceed to the third text data processing step as indicated by block (12C) wherein the same preprocessed data will be pushed to the summarizer service created using JAVA. Then each data will be returned by the summarizer service and this time the mining agent will receive a summarized version of the preprocessed data which will similarly be temporarily stored in a database (13), with predicate “hasSummary” containing the summarized data.

Then, in the final part of converting plain text data to semantic artifact, the mining agent will cause the preprocessed data to enter the fourth text data processing step as indicated by block (12D) wherein the preprocessed data enters a semantic annotation service created using JAVA. Inside this service, semantic annotation will unlock the information about what entities (or, more generally, semantic features) appear in a text and what they do. Formally, semantic annotations represent a specific sort of metadata, which provides references to entities in the form of Uniform Resource Identifiers (URIs) or other types of unique identifiers. Besides performing semantic annotation, this service provides a sort of meta-data and process of generating such meta-data. In a usual manner, the data that returns from this service will be temporarily stored in a database (13).

In the event the data is a binary document a binary data processing step (14) comprising a series of semantic processing applications are applied to the binary data to convert the web data into semantic artifact. For binary data the process is similar to the process of converting text data into semantic artifact but for a slight difference where the mining agent will not take binary data to a summarizer service. This is because binary data contain very limited information such titles and file extensions. Although there is limited information gathered from binary data, it can however provide very important semantic values. In the first binary data processing step as indicated by block (14A), the mining agent will determine the extension of each binary data received. The determination is not carried out using any form of JAVA service because the process is very straight forward. Then the data is classified as document or images or video or audio and based on the extension it will be temporarily stored to a database (13), with the predicate “hasExtension”.

Similar to the previous process described above for processing text data, the mining agent is capable of detecting the mime type of binary data internally as shown in the second binary data processing step as indicated by block (14B). The said detection is simple and does not require a very advanced JAVA service. The mining agent will extract each binary data mime type information such as “Image/Jpeg” for Jpeg Image, “Audio/Basic” for audio and many more and this information will be temporarily stored to a database (13), with predicate “hasMimeType”.

Text information of the binary data such title or small descriptions linked to the binary data will be processed in the third binary data processing step as indicated by block (14C) which is a categorizer service where the said text information is categorized using preferably a JAVA categorizer service. Each binary data will get its own categories returned by this categorizer service and it will be temporarily stored to a database (13), with predicate “hasCategory” and the name of category.

Binary data is not excluded from undergoing semantic annotation service. This annotation service for binary data as shown in the fourth binary data processing step as indicated by block (14D) is capable of annotating binary data based on knowledge base information. This annotation process is similar to the annotation process of text data. All annotated information of each binary data will be temporarily stored in a database (13).

Finally, the user needs to verify all the semantic artifact created and temporarily stored in the said database (13) as shown in the verification step (8). If user is satisfied with the information the web mining agent have gathered from the internet, the user will merely need to click on the “approve” button to confirm the data as verified data for it to be forwarded to the knowledge base store (10) preferably knowledge base RDF or Triples store for permanent storage. The insertion of data will use Simple Protocol and RDF Query Language (SPARQL) extensively.

While the preferred method of the present invention and its advantages has been disclosed in the above Detailed Description, the invention is not limited thereto but only by the spirit and scope of the appended claim.

What is claimed is:

1. A method of semantic web mining comprising steps of,
inserting at least a keyword into the web form;
posting said keyword to a mining agent
collecting data mined from the Internet;
storing data for future knowledge retrieval
characterised in that
the said storing of data is subsequent to determination of the mime (Multi-purpose Internet Mail Extension) type of data collected and after causing the 10 determined type of data to undergo relevant semantic processing application and verification.

2. A method of semantic web mining as in claim 1 wherein the said posting of keyword to the mining agent is subsequent to the keyword being refined;

3. A method of semantic web mining as in claim 2 wherein said refining of keyword is by means of ontology or knowledge base.

4. A method of semantic web mining as in Claim 1 which is capable of determining data collected by the mining agent from the Internet into text or binary data before the application of relevant semantic processes.

5. A method of applying semantic processes for text data as in claim 4 comprising steps of,
pre-processing the said text data to retain pure text with important information only for temporary storage in a database (12A);
categorising the pre-processed text data by using pre-determined calculations and rules for temporary storage in a database (12b);
summarising the pre-processed data into a summerised version for temporary storage in a database (12C);
converting the pre-processed text data into semantic artifact by use of semantic annotation application for temporary storage in a database (12D).

6. A method of applying semantic processes for binary data as in claim 4 comprising steps of,
determining the extension of each binary data received for temporary storage in a database (14A);
extracting each binary data mime type of information for temporary storage in a database (14B);
categorising the pre-processed binary data by using pre-determined calculations and rules for temporary storage in a database (14C);
converting the pre-processed binary data into semantic artifact by use of semantic annotation application for temporary storage in a database (14D).

7. A method of semantic web mining as in claim 5 which allows the user to verify the data stored in the said temporary storage database (13) before forwarding it to knowledge base store (10) for permanent storage.

8. A method of semantic web mining as in claim 1 which is capable of use in extensive or populate semantic artifacts.
